(19) United States
(12) Patent Application Publication
(10) Pub. No.: US 2017/0228785 A1
(43) Pub. Date: Aug. 10, 2017

(54) Method and System That Manages Geo-Fence Objects Using Automated Auctioning

(71) Applicant: FANTEQ Corp., Milton, GA (US)

(72) Inventor: Bryon Evje, Milton, GA (US)

(73) Assignee: FANTEQ Corp., Milton, GA (US)

(21) Appl. No.: 15/423,550

(22) Filed: Feb. 2, 2017

Related U.S. Application Data
(60) Provisional application No. 62/291,011, filed on Feb. 4, 2016.

(51) Int. Cl. G06Q 30/02; H04W 4/02

(52) U.S. Cl. CPC G06Q 30/0261; H04W 4/022; G06Q 30/0275

(57) ABSTRACT

A system and method for managing geofence objects includes a database storing geo-fence objects and at least one module configured to automatically initiate an auction process involving a plurality of users in response to determining conflict between geo-fence objects owned or controlled by the plurality of users.

### CROSS-REFERENCE TO RELATED APPLICATIONS

The present disclosure claims priority from U.S. Provisional Patent Appl. No. 62/291,011, filed on Feb. 4, 2016, herein incorporated by reference in its entirety.

### BACKGROUND

1. Field

The present disclosure relates to geo-fence technology. More particularly, the present disclosure relates to methods and system for managing control of geo-fence objects via automated auction processes.

2. State of the Art

With the proliferation of mobile computing devices incorporating location services (such as global positioning system (GPS) technology or near field communications capabilities), information can be provided to a mobile device on demand based on its current location.

Geo-fence objects define virtual geographic boundaries. A key aspect of a geo-fence object is the ability of a mobile device to automatically interact with an application or service upon entering a geographical boundary covered by a particular geo-fence object.

Services that incorporate geo-fencing allow an administrator to set up geo-fence objects such that when a user's mobile device enters the geographical boundaries defined by an administrator, a text message, email alert, push notification, or some other message is communicated to the user's mobile device. The technology has many practical uses, but marketing uses have gained the most significant attention. For example, a marketer or retailer can define a geo-fence object that covers a retail store in a mall and send a coupon or promotion to a customer who has downloaded a particular mobile app when the customer (and his smartphone) enters the retail store. As another example, a retailer can define a geo-fence object that triggers pushing an advertisement to a customer when a user crosses a boundary while traveling in a vehicle.

This allows marketers and retailers to engage shoppers within a defined locale. This further allows marketers and retailers to leverage a user's location, to move them toward making a purchase at a particular retailer or service provider, or to move them away from a competitor. That is, ads can target users as they approach competitors to try to attack their business. Furthermore, pushed ads can offer complementary products; i.e., an offer for flowers as a customer enters a jewelry store.

As such, the placement and types of flags within geo-fences can provide marketers and retailers with an advantage over competition.

Systems have been suggested to assign value to flags within geo-fences among competitors. By way of example, US Pub. No. 2013/0212065 to Rahnama describes assigning value to a flag within a zone based on estimates of value or auction bidding in view of size of geographical zone, an attribute associate with the zone, and/or cost for covering a demographic.

### BRIEF DESCRIPTION OF THE DRAWINGS

FIG. 1 is a schematic view of the networked environment that embodies an electronic service for managing geo-fence objects according to the present disclosure.

FIGS. 2A-2D, collectively, are a flow chart illustrating operations carried out by the auction module of the service of FIG. 1.

FIGS. 3A-3C are schematic illustrations of exemplary geo-fence objects that are processed by the auction module of the service of FIG. 1 during certain operations of FIGS. 2A-2D.

FIG. 4 is a schematic view of additional functionality of the service of FIG. 1 that supports the creation and management of publisher-type geo-fence objects.

FIGS. 5A-5C are an exemplary graphical user interface that is presented to a merchant to allow the merchant to specify one or more category attributes as well as the geographical boundary for one or more public-type geo-fence objects for that merchant.

### DETAILED DESCRIPTION OF THE PREFERRED EMBODIMENTS

It should be noted that while the following description is drawn to a computer based system for management of geo-fence objects together with services and/or communications associated therewith, various alternative configurations are also deemed suitable and may employ various computing devices including servers, interfaces, systems, databases, agents, peers, engines, controllers, or other types of computing devices operating individually or collectively. One should appreciate the elements of the system (including the service 15, the user electronic devices 11A, 11B, 11C, and the merchant computing devices) can include one or more processors configured to execute software instructions stored on a tangible, non-transitory computer readable storage medium (e.g., hard drive, solid state drive, RAM, flash, ROM, etc.). The software instructions preferably configure the respective elements to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, web service APIs, or other electronic information exchanging methods. Data exchanges preferably are conducted over one or more packet-switched networks, such as packet switched radio access networks (e.g., GRAN or GSM radio access network, UTRAN or UMTS radio access network, E-UTRAN or Long Term Evolution (LTE) high speed and low latency radio access network, and Wi-Max radio access networks), packed switched carrier core networks, the Internet, LAN, WAN, Wi-Fi, VPN, or other types of IP-based and packet switched networks.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Further, within the context of this document “coupled to” and “coupled with” are also used to mean “communicatively coupled with” over a network, possibly via one or more intermediary nodes.

The following discussion describes the management geo-fence objects together with services and communications associated therewith. A geo-fence object as described herein is a computer-implemented data structure that defines a virtual perimeter for a real-world geographic area. A geo-fence object can be considered a virtual object having extent that is overlaid on real-world geo-location boundaries. The geo-fence object can provide access to a particular service and/or communication associated with the geo-fence object. The virtual perimeter of the geo-fence object can be defined in terms of one or more geo-location coordinates. The geo-fence object can also possibly define additional attributes as described herein. A participating mobile user who enters the geographic area of a given geo-fence object is considered to trip the geo-fence object and can be provided with access the particular service and/or communication that is associated with that given geo-fence object.

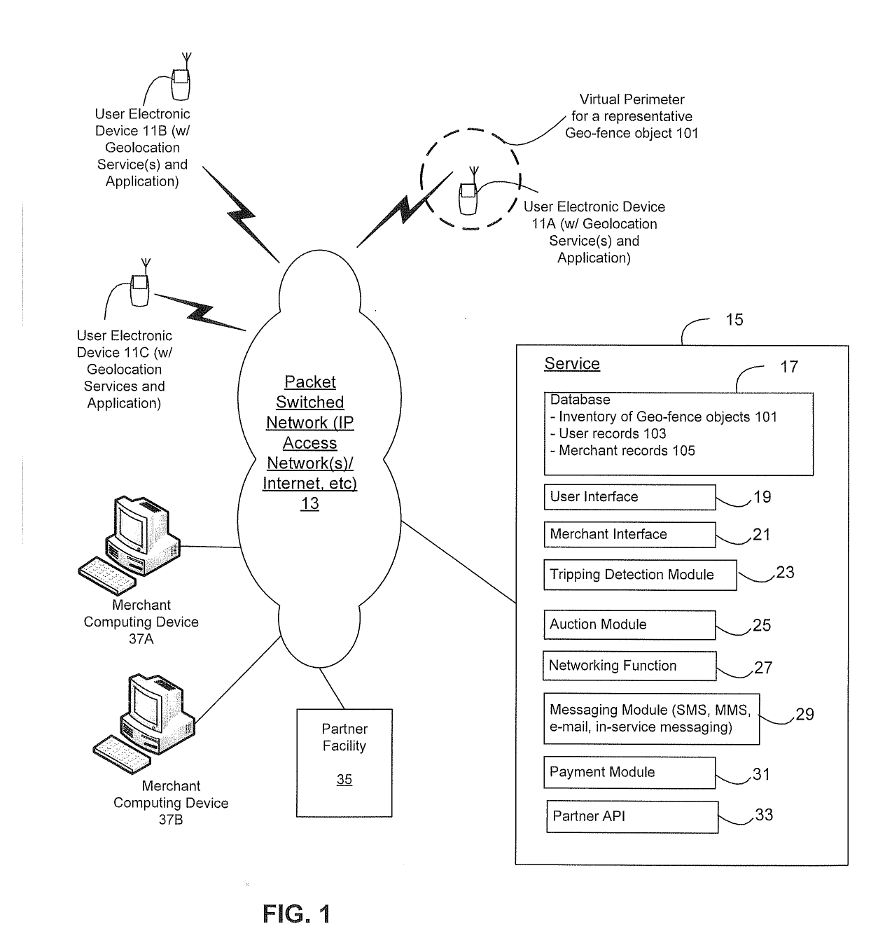

FIG. 1 presents a service or system 15 that operates to manage one or more geo-fence objects 101. In the example illustrated, a representative geo-fence object 101 has been defined to have a virtual perimeter that extents over a geographical region and is associated with one or more defined services or communications that can be carried out by operation of the service 15. When an electronic device 11A operated by a participating mobile user enters the geographic area of the representative geo-fence object 101 and trips the representative geo-fence object 101, the service 15 exchanges data with the electronic device 11A over the packet switched network 13 to provide access to the services and/or communications associated with the representative geo-fence object 101. The exchange of data between the electronic device 11A and the service 15 can use standardized protocols or algorithms, possibly based on HTTP, HTTPS, AES, web service APIs, known financial transaction protocols, or other electronic information exchanging methods. The packet switched network 13 can include packet switched radio access networks (e.g., GRAN or GSM radio access network, UTRAN or UMTS radio access network, E-UTRAN or Long Term Evolution (LTE) high speed and low latency radio access network, and Wi-Max radio access networks), packed switched carrier core networks, the Internet, LAN, WAN, Wi-Fi, VPN, or other types of IP-based and packet switched networks. Example electronic devices 11A, 11B, 11C capable of operating with the service 15 can include a mobile phone (such as a smart phone or cell phone), a tablet or notebook computer, a smart watch, a hand-held GPS device, a vehicle or boat, or other mobile computing devices.

The service 15 includes a database 17, one or more user interfaces 19, one or more merchant interfaces 21, a tripping detection module 23 that detects tripping of geo-fence objects by participating mobile users, and an auction module 25. The service 15 can also include additional services, such as a networking function 27, a messaging module 29, and a payment module 31.

The database 17 can be configured to store an inventory of one or more geo-fence objects 101. Example databases 17 can comprise a cloud-based storage array, distributed database, a local database, or other forms of databases. The geo-fence objects 101 can be separately managed as distinct objects and can include a plurality of attributes, possibly stored as metadata, describing the nature of the corresponding geo-fence object. The geo-fence objects 101 can include private-type geo-fence objects and public-type geo-fence objects. The private-type geo-fence objects are owned or controlled by participating users (typically the consuming public) of the service 15. The private-type geo-fence objects are also intended to be accessed by a limited set of mobile participating users of the service 15. The public-type geo-fence objects are owned or controlled by merchants, retailers, advertisers, business owners, ad networks, ad exchanges, demand-side platforms (DSPs), rep firms, promoters or agencies or some other commercial entity (collectively referred to as “merchant” or “merchants” herein) that are registered with the service 15. It is also contemplated that public-type geo-fence objects can be owned or controlled by non-commercial entities, such as participating users of the service 15 or by public entities for beacon broadcasting. For example, representatives of smart city can integrate public-type geo-fence objects that pertain to destinations in and around the city as part of the service 15. In this case, the public-type geo-fence objects can operate as beacon messages that are communicated to mobile users by the service on behalf of the city. The public-type geo-fence objects are category-based as described herein and are intended to be accessed by all participating users of the service 15 who have opted into particular categories for encountering corresponding category-based geo-fence objects as described herein.

In one embodiment, the attributes of a geo-fence object 101 can include the following:
i) one or more attributes that represent or identify the user that controls or owns the geo-fence object; for a private-type geo-fence object, the identified user can be a participating user of the service 15 (typically, a member of the consuming public); for a public-type geo-fence object, the identified user can be a merchant that is registered with the service 15;
ii) one or more attributes representing a virtual perimeter of the geo-fence object, such as GPS latitude and longitude coordinates for the center along with a radius (typically in meters or miles) of a circular perimeter; the radius can be selected from a limited set of possible radii, such as eight radii in the range from 20 meters to 5 miles;
iii) an attribute representing a particular category; this category belongs to a predefined set of categories; the use of categories permits category-based restriction of the overlap between multiple public-type geo-fence objects; in one embodiment, multiple public-type geo-fence objects of different categories can overlap in geographic area while multiple public-type geo-fence objects of the same category cannot overlap in geographic area; in other words, the perimeters of multiple public-type geo-fence objects of different categories can partially or fully cover the same geographic area, while the perimeters of multiple public-type geo-fence objects of the same category cannot partially or fully cover the same geographic area; the predefined set of categories can vary widely according to the design of the system; in one embodiment, the predefined set of categories can include one or more of the following: Autos, Concerts, Conferences, Deals, Education, Festivals, Film, Food, Fundraisers, Galleries, Health, Jobs, Landmarks, Museums, Social and/or Business Networking, News, Nightlife, On Campus, Organizations, Outdoors, Performing Arts, Pets, Real Estate, Religion, Shopping (and/or particular goods or services such as Wine, Beer, etc.), Sports (and/or particular sports), Technology, Traffic, Travel, Weather, Other;
iv) an attribute representing geo-fence object type (public or private); private-type geo-fence objects can be accessed by a limited set of users; and private-type geo-fence objects can overlap in geographic area without restriction, in contrast to public-type geo-fence objects as described above;
v) one or more attributes representing a set of users; for a private-type geo-fence object, access to the private-type geo-fence object is limited to this set of users; for a public-type geo-fence object, access is not limited to this set of users; instead all users can potentially access the public-type geo-fence object; in both cases, any user of the set can be invited to join the service 15 if not currently a registered user;
vi) one or more attributes that is used to present information to and/or initiate interaction with a participating user that has triggered the geo-fence object by entering into the geographic area covered by the geo-fence object; such information can be promotional material (particularly for public-type geo-fence objects), such as an offer, deal, coupon, advertisement, special menu item, upcoming concert detail, etc.; such information can include a reference to one or more media files (or the files themselves); the media file(s) can encode messages, images, audio content, video content, etc.; the media file(s) can be related to the business of the owner of the geo-fence object and/or promotional material that is referenced by the geo-fence object;
vii) one or more attributes related to the scheduling of the geo-fence object, such as the data and time when the geo-fence object will be active (e.g., live) and thus made accessible to relevant users of the service 15 as well as the data and time that the geo-fence will expire and thus made inaccessible to relevant users of the service 15; and
viii) one or more attributes related to per user trip frequency; more specifically, information related to the number of times that each given user can trip the geo-fence object; for example, the per user trip frequency can specify that each given user can a) trip the geo-fence only once, or b) repeatedly trip the geo-fence upon every instance that the given user enters into the geographic region covered by the geo-fence.

It is also contemplated that the geo-fence objects can be defined through the use of templates. A template is a generic class or other unit of information that can be used as the basis for defining the geo-fence objects. Different types of templates can be defined for different types of geo-fence objects.

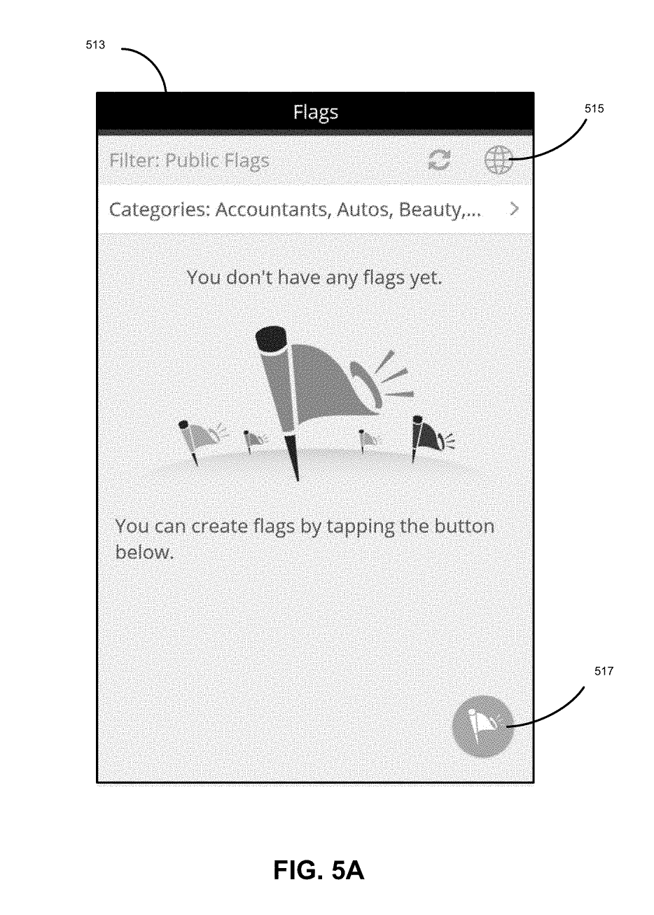

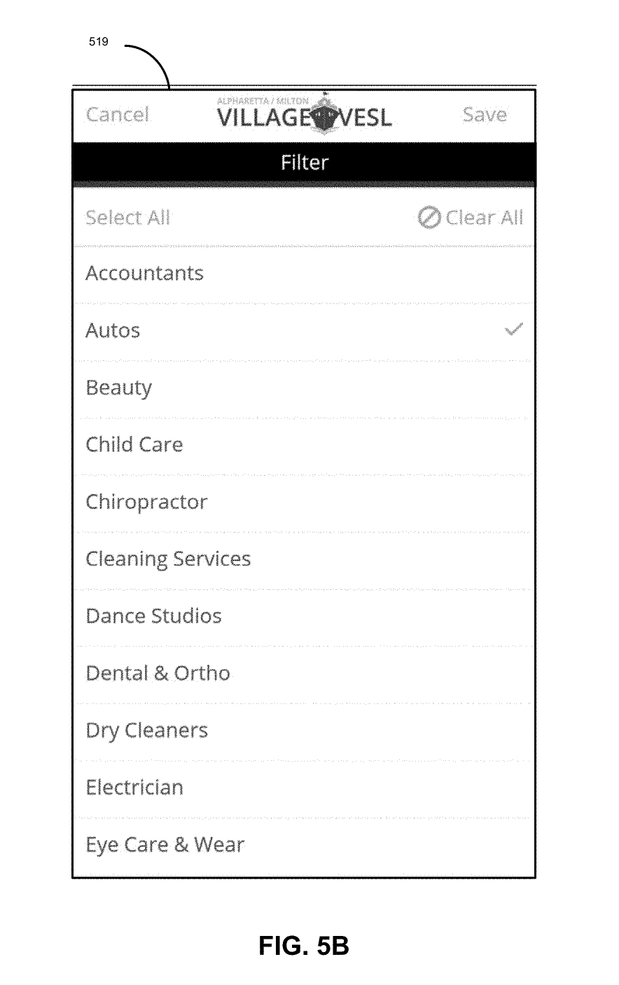

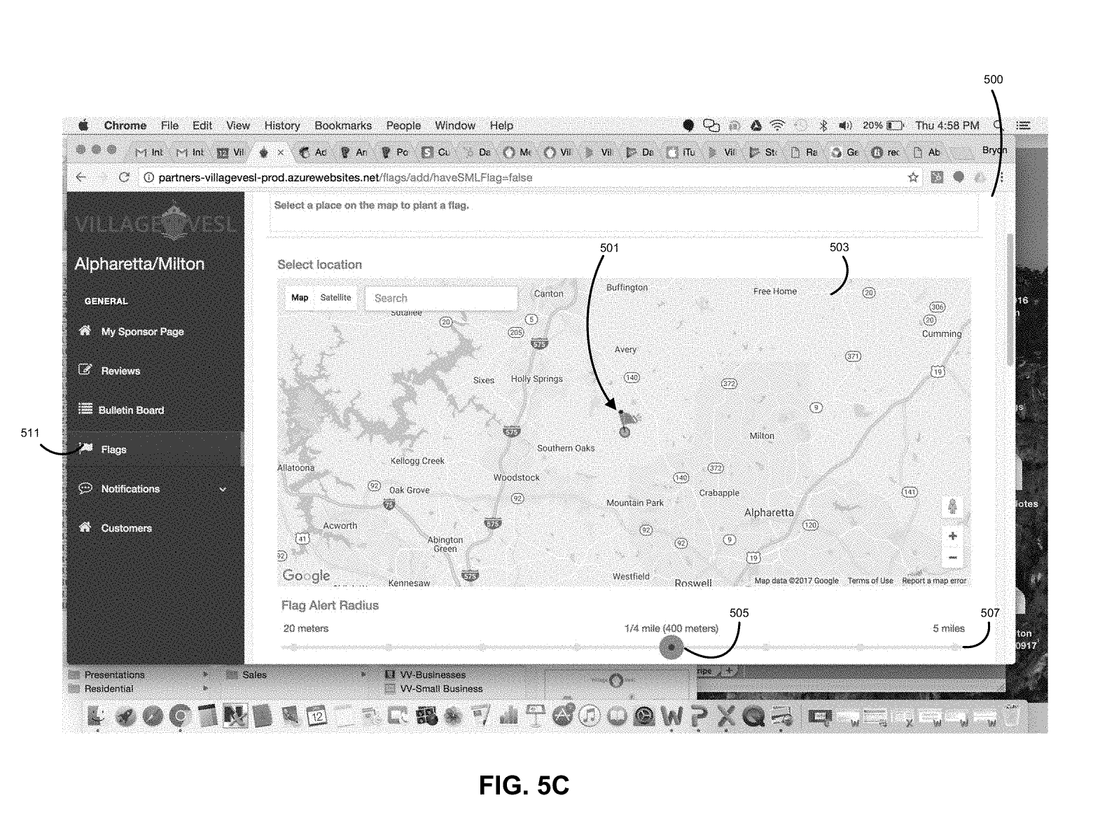

The user interface 19 allows the elements of the service 15 to interact with the electronic devices 11A, 11B, 11C, etc. operated by the participating users over the packet switched network 13. It is contemplated that the user interface 19 can include an API into an operating system or middleware that supports data exchange with the electronic devices 11A, 11B, 11C, etc. Different types of user interfaces 19 are also contemplated. In one embodiment, the respective electronic devices 11A, 11B, 11C, etc. can establish a connection (e.g., a TCP/IP connection, a session, an asynchronous connection, etc.) with the user interface 19, possibly via the operating system of the electronic device. Once the connection is established, the electronic device and user interface 19 can maintain the connection. The user interface 19 cooperates with one or more applications (such as a web browser, a special purpose application branded by the service 15 or other suitable application) that execute on respective electronic devices 11A, 11B, 11C, etc. operated by the participating users to provide for data exchange that allows for a number of functions including user registration and user authentication. The user authentication can utilize user data (such as a user name and password) defined during user registration and stored in user records 103 of the database 17. Authorized users can also define one or more private-type geo-fence objects. In order to define a private type geo-fence object, the authorized user can be presented with a map, possibly provided by Google® maps or other provider within a web browser or application window interface. The authorized user can then specify an area on the map (for example, by specifying the center and radius of a perimeter circle) which represents the geographical boundaries for the private-type geo-fence object. Such operations are similar to those shown and FIG. 5 and described below for public-type geo-fence objects. In alternate embodiments, the authorized user can define the geographical boundaries for the private-type geo-fence object based on many different factors including area and altitude, building floor plan, a street or neighborhood boundary, or other information. These actions can be used to specify the one or more attributes representing the virtual perimeter of the geo-fence object as listed above. The interaction with the authorized user can also be used to specify other attributes of the private-type geo-fence object, such as one or more attributes representing a particular category, one or more attributes representing geo-fence object type (public or private), one or more attributes representing a set of users, one or more attributes that is used to present information to and/or initiate interaction with a participating user that has triggered the geo-fence object, one or more attributes related to the scheduling of the geo-fence object and one or more attributes related to per user trip frequency. It is also contemplated that the interaction with the authorized user can edit one or more attributes for any existing private-type geo-fence object that is owned or controlled by the authorized user. For example, such interaction can be used to modify or alter the geographical boundaries or other attributes of an existing private-type geo-fence object. It is also contemplated that the interaction with the authorized user allows the user to pick or otherwise specify one or more categories of interest from a list of predefined categories that are associated with the public-type geo-fence objects of the service 15. By picking a particular category of interest, the authorized user effectively opts in to tripping and accessing the public-type geo-fence objects that match the particular category when located within the geo-graphical boundary of such geo-fence objects. Note that such category user preferences are specified on a user-by-user basis in order to tailor the interaction of the users with the public-type geo-fence objects of the service 15 based on the particular interest categories of the users.

The merchant interface 21 allows the elements of the service 15 to interact with the computing devices 37 operated by merchants over the packet switched network 13. Example merchant computing devices 37 capable of operating with the service 15 can include PCs, tablet or notebook computers, mobile phones (such as a smart phones), and computing devices. It is contemplated that the merchant interface 21 can include an API into an operating system or middleware that supports data exchange with the merchant computing devices 37. Different types of merchant interfaces 21 are also contemplated. In one embodiment, the respective merchant computing devices 37 can establish a connection (e.g., a TCP/IP connection, a session, an asynchronous connection, etc.) with the merchant interface 21, possibly via the operating system of the merchant computing device. Once the connection is established, the merchant computing device and merchant interface 21 can maintain the connection. The merchant interface 21 cooperates with one or more applications (such as a web browser, a special purpose application branded by the service 15 or other suitable application) that execute on respective merchant computing devices 37 operated by merchants to provide for data exchange that allows for a number of functions including merchant registration and merchant authentication. The merchant authentication can utilize merchant data (such as a merchant name and password) defined during merchant registration and stored in merchant records 105 of the database 17. Authorized merchants can also define one or more public-type geo-fence objects. In order to define a public-type geo-fence object, the authorized merchant can be presented with a map, possibly provided by Google® maps or other provider within a web browser or application window interface. The authorized merchant can then specify an area on the map (for example, by specifying the center and radius of a perimeter circle) which represents the geographical boundaries for the private-type geo-fence object.

In one embodiment shown in FIGS. 5A-5C, the merchant interface 21 can be embodied by a web browser interface window 500 (FIG. 5C) with a control box 511 labeled “flags” as best shown in FIG. 5C. In response to the authorized merchant user selecting the “flags” control box 511 via user input, the interface window 513 of FIG. 5A is presented and displayed to the merchant user with button 515 and button 517. In response to the authorized merchant user selecting the button 515 by user input, the interface window 519 of FIG. 5B is presented and displayed to the merchant user. Interface window 519 presents and displays a list of pre-defined categories (such as Accountants, Autos, Beauty, Child Care, Chiropractor, Cleaning Services, Dance Studios, Dental and Ortho, Dry Cleaners, Electrician, Eye Care & Wear, etc.) that can be associated with the public-type geo-fence objects for the authorized merchant user. The merchant user can select one or more pre-defined categories as presented in the list. In response to such selection, one or more predefined category attributes that correspond to the user-selected categories of the list can be associated with the merchant user and then associated to one or more public-type geo-fence objects specified by the merchant user. The merchant user initiates the specification of such public-type geo-fence objects by selection of button 517 in the interface window 513 of FIG. 5A via user input. This selection presents the authorized merchant with a map area 503 provided by Google® maps as shown in FIG. 5C. The authorized merchant specifies the geographical boundaries of a public-type geo-fence object by locating a “flag-like” icon 501 on the map area 503 (preferably by clicking and/or dragging user input). The location of the “flag-like” icon 501 specifies the center of the geographical boundary for the private-type geo-fence object. The authorized merchant can drag a slider element 505 along a slider bar 507 that is displayed alongside the map area 503 in order to specify a radius. In the example of FIG. 5C, the radius can be specified within a range from 20 meters to 5 miles as represented by different positions of the slider element 505 along a slider bar 507 as shown. The specified radius together the location of the “flag-like” icon 501 specifies a circular geographical boundary for the private-type geo-fence object, where the latitude and longitude coordinates of the location of the “flag-like” icon 501 represent the center of the circular geographical boundary, and the specified radius represents the radial offset of the circular geographical boundary relative to its center. In alternate embodiments, the authorized merchant can define the geographical boundaries for the public-type geo-fence object based on many different factors including area and altitude, building floor plan, a street or neighborhood boundary, or other information. These actions can be used to specify the one or more attributes representing the virtual perimeter of the geo-fence object as listed above. The interaction with the authorized merchant can also be used to specify other attributes of the public-type geo-fence object, such as one or more attributes representing geo-fence object type (public or private), one or more attributes representing a set of users, one or more attributes that is used to present information to and/or initiate interaction with a participating user that has triggered the geo-fence object, one or more attributes related to the scheduling of the geo-fence object and one or more attributes related to per user trip frequency. It is contemplated that the category attributes for the geo-fence objects of a particular merchant can be defined (at least initially) by one or more shared or default category attributes as selected by the particular merchant. It is also contemplated that the interaction with the merchant can edit one or more attributes for any existing public-type geo-fence object that is owned or controlled by the merchant. For example, such interaction can be used to modify or alter the geographical boundaries or other attributes of an existing public-type geo-fence object.

The merchant interface 21 can also provide reports to an authorized merchant related to user interaction with the public-type geo-fence objects that are owned or controlled by the authorized merchant. Such reports can include information related to geo-fence objects that are owned or controlled by the authorized merchant (such as statistics including trip (impression) count, trip (impression) frequency, click count, click frequency, recipient user identity, and costs. It is contemplated that the geo-fence objects can be grouped into one or more campaigns and the information for the geo-fence objects that are part of a particular campaign can be aggregated together for review of the particular campaign.

In other embodiments, the merchant interface 21 can be embodied by a smartphone or computer application (or app) that is downloaded or otherwise installed on a suitable computing device (e.g., smartphone or other computing device) for interaction with a merchant user. In this case, similar window interfaces can be presented to the merchant user as those shown in FIGS. 5A-5C to allow the merchant user to specify one or more category attributes as well as the geographical boundary for one or more public-type geo-fence objects for that merchant user.

The tripping detection module 23 is configured to obtain location data from the respective electronic devices 11A, 11B, 11C, etc. of participating mobile users via the user interface 19. The location data can be obtained through various techniques including a push model, pull model, polling model, or other communication techniques. When context dictates, the electronic device of the participating mobile user can communicate the location data to the tripping detection module 23 via the user interface 19. The location data specifies the geographic location of the electronic device. It can be derived from location-based services provided by the operating system of the electronic device or some other means. Typically, such location data is derived by a GPS system that is part of the device, multilateration of the signal from cell sites serving the mobile device, or some other means. The tripping detection module 23 can use the location data to query the inventory of public-type geo-fence objects maintained by the database 17 in order to determine one or more public-type geo-fence objects whose geographic area encompasses the location of the electronic device operated by a participating mobile user and whose category attribute data matches the category preferences of the participating mobile user (i.e., the category(ies) of public-type geo-fence objects that the participating mobile user is interested in). The tripping detection module 23 can automatically provide the electronic device with access to the service and/or communication associated with the determined public-type geo-fence object(s). The tripping detection module 23 can also use the location data to query the inventory of private-type geo-fence objects maintained by the database 17 in order to determine one or more private-type geo-fence objects whose geographic area encompasses the location of the electronic device operated by the participating mobile user and whose user set attribute data includes the participating mobile user. The tripping detection module 23 can automatically provide the electronic device with access to the service and/or communication associated with the determined private-type geo-fence object(s).

The service and/or communication associated with a particular geo-fence object can cover a broad spectrum of capabilities or responsibilities, such as providing access to multi-media objects (e.g., video, music, images, etc.), IMS or MMS messaging, e-mail messaging, native or binary applications, web components, map or geographical based interfaces, communication components, feedback interfaces, notifications, reminders, appointments, sensor access, camera access or other types of services. Although the examples as listed above provide access capabilities to the electronic device, the service and/or communication associated with a particular geo-fence object can provide the service 15 with access to information maintained or accessible from the electronic device, such as device sensors, device security features, device or user identity, device application outputs, or other device information can be carried out through various techniques. Note that the service and/or communication associated with a particular geo-fence object can be considered applications or even portions of applications in a distributed execution ecosystem. For example, the service and/or communication associated with a particular geo-fence object can involve launching or activating web services at a specific domain (e.g., URL, TLD, etc.) or even port assignment on a web server. The web server could comprise an actual server local to a geo-fence object's geographic location if it has one, a remote server, or even a cloud-based implementation. Further, the e service and/or communication associated with a particular geo-fence object can involve one or more APIs (e.g., web services, remote procedure calls, etc.) through which an application on an electronic device can interact with the service 15.

The service 15 can also include a networking function 27 that provides support for the data exchange to and from the service, such as TCP/IP functions, web services, remote procedure calls, etc. The networking function can be used other elements, such as the user interface 19 and merchant interface 21, in order to carry out data exchange to and from the service.

The service 15 can also include a messaging module 29 that provides support for messaging services to users and/or merchants that are registered with the service. Such messaging services can include SMS messaging, MMS messaging, e-mail messaging and in-service messaging.

The service 15 can also include a payment module 31 that cooperates with commercially available payment systems (such as credit card processing systems, Paypal, Google Wallet, Apple Pay, etc.) in order to collect payments from merchants and/or users of the service as needed.

In one embodiment, the service 15 operates as a for-fee service with an auction module 25 that employs automatic conflict checking for each newly defined public-type geo-fence object in order to determine if the newly defined public-type geo-fence object conflicts with any other existing (and active) public-type geo-fence object owned or controlled by another merchant as stored in the inventory of geo-fence objects 101 maintained by the database 17. Conflict between two or more public-type geo-fence objects owned or controlled by different merchants is dictated by the two or more public-type geo-fence objects sharing the same category and having overlap in geographic area. In the event of such conflict, an auction process is carried out between the merchants that own or control the conflicting public-type geo-fence objects. Only one of such merchants will win the auction. The winner merchant pays the price determined by the results of the auction. Thereafter, the service 13 can add the geo-fence object owned or controlled by the winner merchant to the inventory of geo-fence objects 101 maintained by the database 17, if not there already. It will become active during its relevant term. For the case where the winner merchant is the merchant that defined the newly created public-type geo-fence object, the term of the newly created public-type geo-fence object is determined by the service. For the case where the winner merchant is the merchant that owns or controls an active public-type geo-fence object that conflicts with newly created public-type geo-fence object, the term of the active public-type geo-fence object is extended as a result of the auction process. The service 13 can also processes the public-type geo-fence object created or controlled by each loser merchant. For the case where the loser merchant is the merchant that defined the newly created public-type geo-fence object, the newly created public-type geo-fence object can be discarded such that it is not placed in the inventory of geo-fence objects 101 maintained by the database 17. For the case where the loser merchant is the merchant that owns or controls an active public-type geo-fence object that conflicts with newly created public-type geo-fence object, the public-type geo-fence object can be marked inactivate or removed from the inventory of geo-fence objects 101 at the ends of its term.

The elements of the service 15 as referenced above can take on many different forms. In some embodiments, the elements of the service 15 can manage multiple geo-fence objects for many different merchants and users. In one embodiment, the elements of the service 15 can be hosted in a cloud-based architecture. The elements of the service 15 can be a dedicated piece of hardware, a virtual machine, or other configuration of hardware and software. Example infrastructures that can be used as part of the service 15 include a cloud-based service (e.g., Amazon® EC2; Microsoft® Azure, Google® Cloud, etc.), a for-fee based service, a connection-oriented or a connection-less server (e.g., HTTP, UDP, etc.), a peer-to-peer service, a privately hosted service, a virtual machine, or other computing infrastructure.

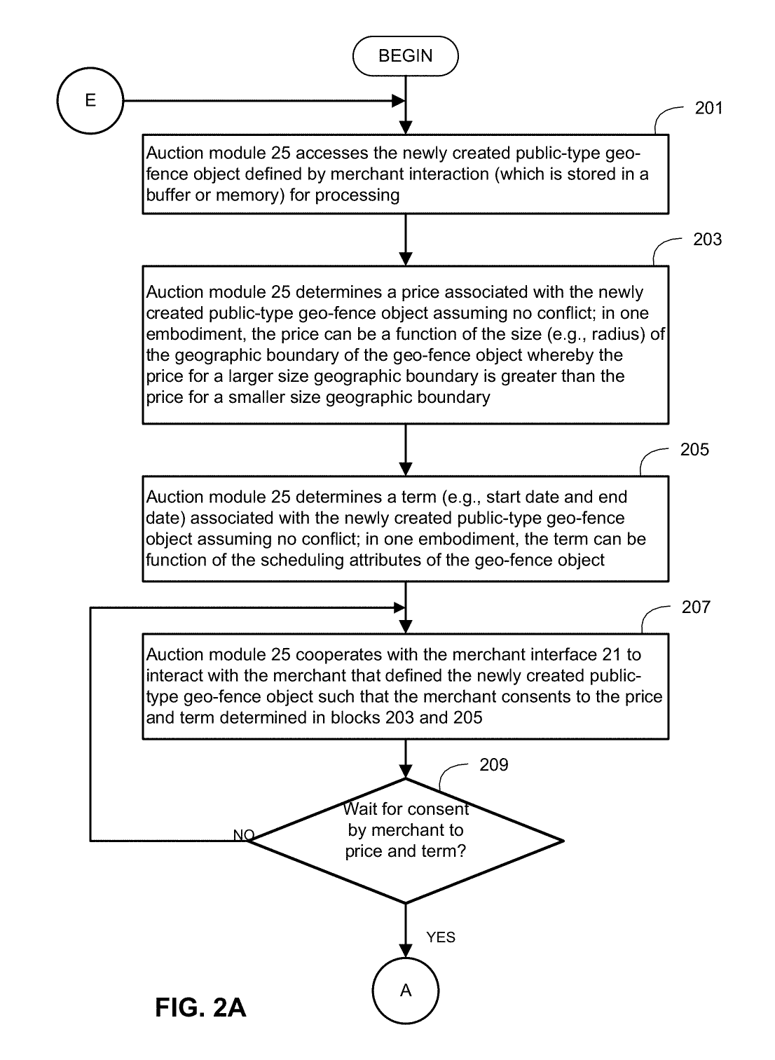

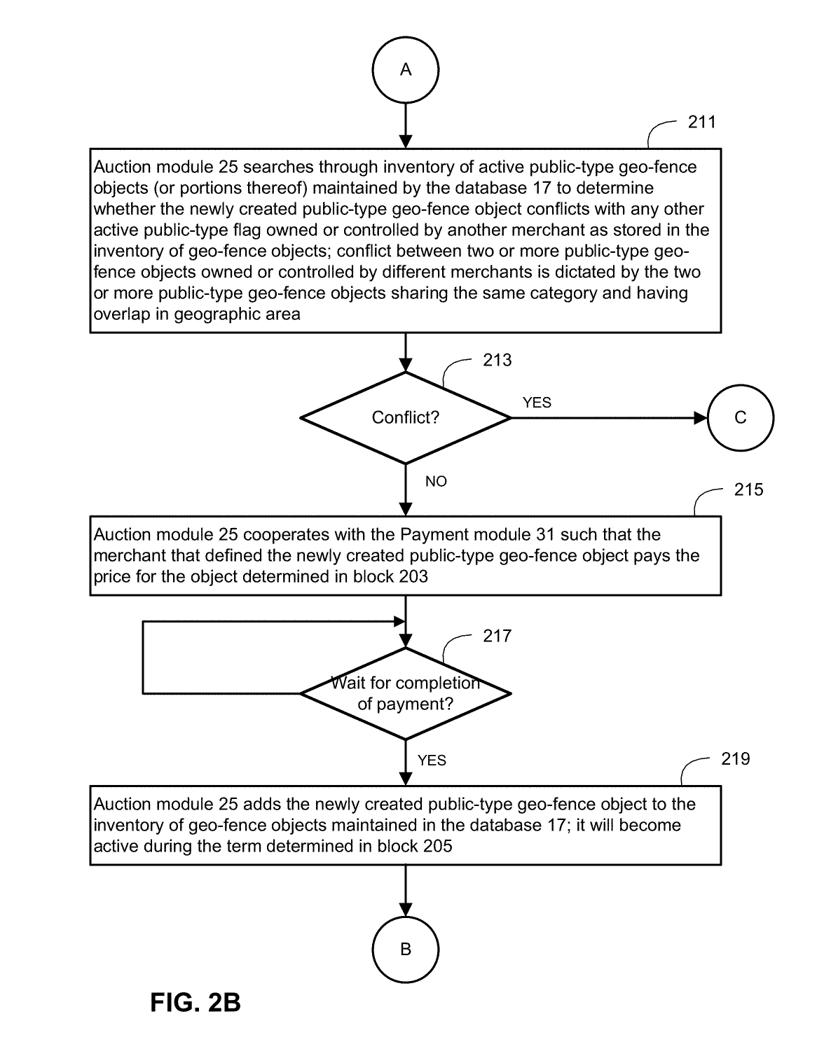

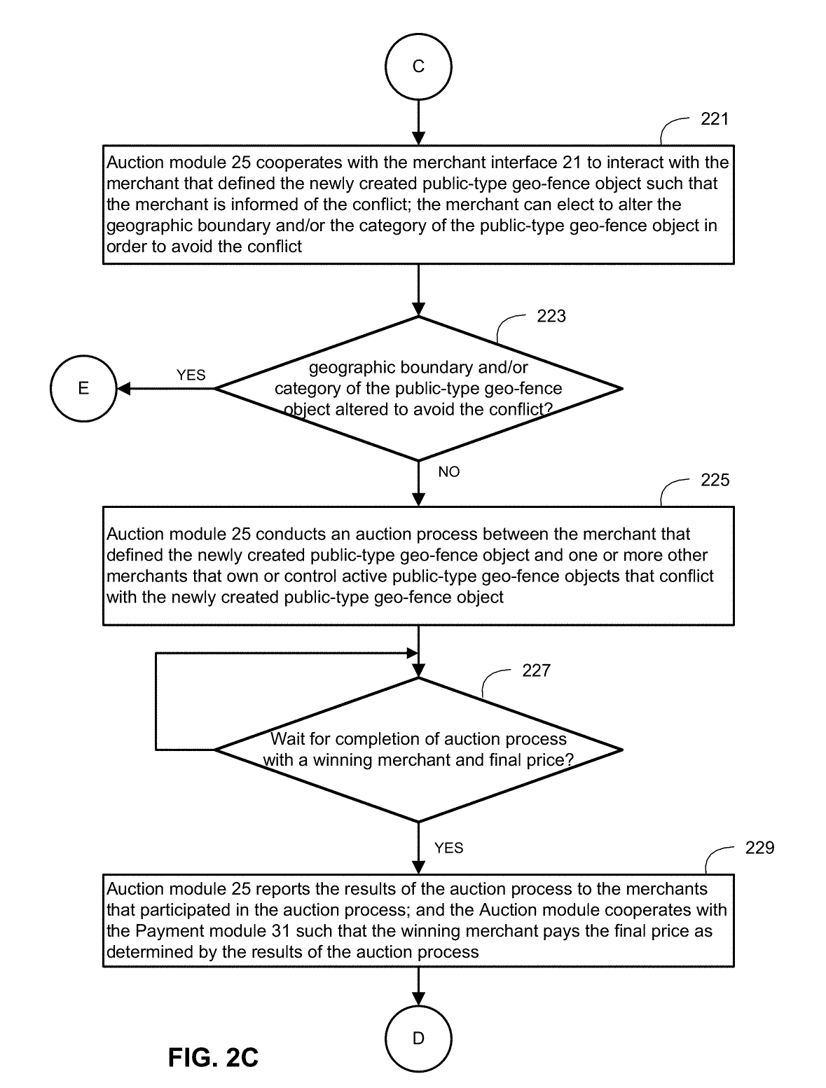

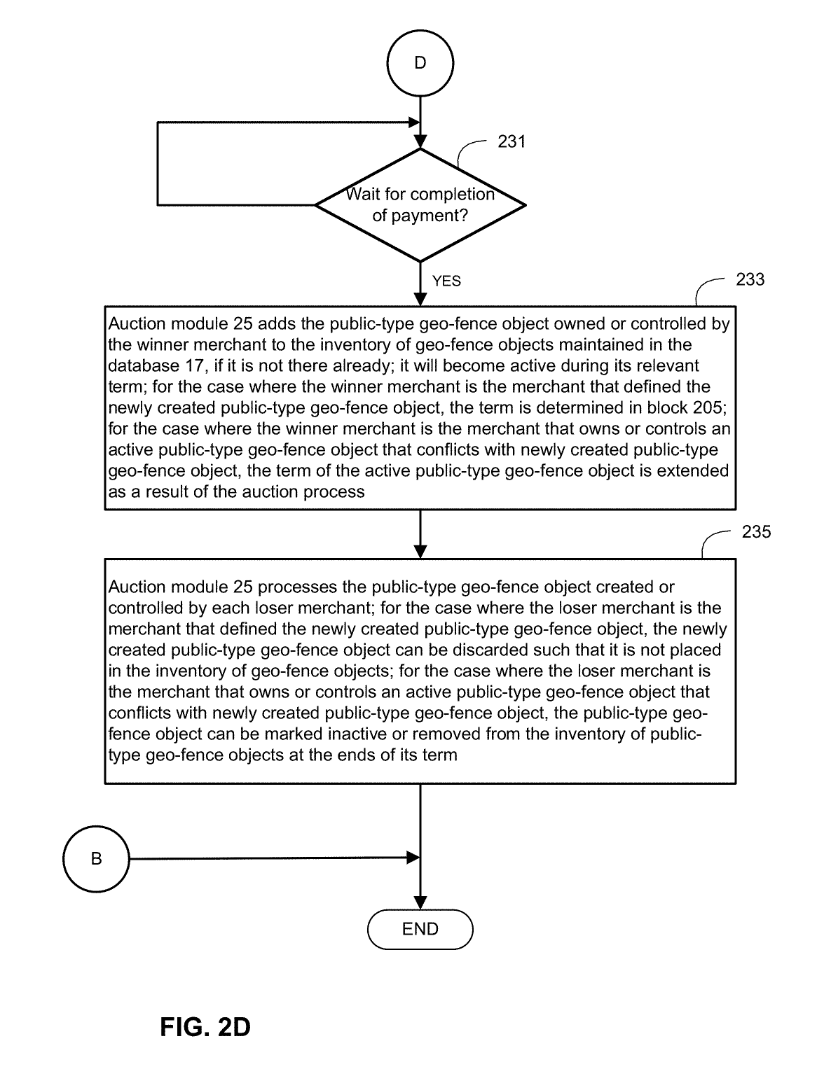

FIGS. 2A to 2D illustrate exemplary operations carried out by the auction module 25 in processing public-type geo-fence objects that are defined by merchant interaction with the merchant interface 21. The operations being in block 201 where the auction module 25 accesses a newly created public-type geo-fence object defined by merchant interaction with the merchant interface 21. This newly created public-type geo-fence object is stored in a buffer or memory and accessed by the auction module for processing.

In block 203, the auction module 25 determines a price associated with the newly created public-type geo-fence object assuming no conflict. In one embodiment, the price can be a function of the size (e.g., radius) of the geographic boundary of the geo-fence object whereby the price for a larger size geographic boundary is greater than the price for a smaller size geographic boundary.

In block 205, the auction module 25 determines a term (e.g., start date and end date) associated with the newly created public-type geo-fence object assuming no conflict. In one embodiment, the term can be function of the scheduling attributes of the geo-fence object.

In block 207, the auction module 25 cooperates with the merchant interface 21 to interact with the merchant that defined the newly created public-type geo-fence object such that the merchant consents to the price and term determined in blocks 203 and 205.

In block 209, the auction module is configured to wait for consent by the merchant to the price and term determined in blocks 203 and 205. Upon receiving such consent, the operations continue to block 211.

In block 211, the auction module 25 searches through inventory of active public-type geo-fence objects (or portions thereof) maintained by the database 17 to determine whether the newly created public-type geo-fence object conflicts with any other active public-type flag owned or controlled by another merchant as stored in the inventory of geo-fence objects 101. Conflict between two or more public-type geo-fence objects owned or controlled by different merchants is dictated by the two or more public-type geo-fence objects sharing the same category and having overlap in geographic area.

In block 213, the auction module 25 checks if such conflict exists between the newly created public-type geo-fence object and any other active public-type flag owned or controlled by another merchant. If not, the operations continue to blocks 215 to 219. If so, the operations continue to block 221.

For the case of no conflict, in block 215 the auction module 25 cooperates with the payment module 31 such that the merchant that defined the newly created public-type geo-fence object pays the price for the object determined in block 203.

In block 217, the auction module 25 is configured to wait for completion of payment by the merchant that defined the newly created public-type geo-fence object. Upon completion of such payment, the operations continue to block 219.

In block 219, the auction module 25 adds the newly created public-type geo-fence object to the inventory of geo-fence objects 101 maintained in the database 17 and the operations end. Note that the public-type geo-fence object will become active during the term determined in block 205.

For the case of conflict, in block 221, the auction module 25 cooperates with the merchant interface 21 to interact with the merchant that defined the newly created public-type geo-fence object such that the merchant is informed of the conflict. Such operations can also involve messaging to the merchant via the messaging services provided by the messaging module 29. The merchant can elect to alter the geographic boundary and/or the category of the public-type geo-fence object in order to avoid the conflict.

In block 223, the auction module 25 checks if the merchant has elected to alter the geographic boundary and/or the category of the public-type geo-fence object and avoid the conflict. If so, the operations revert to block 201 to repeat the process for the altered public-type geo-fence object. If not, the operations continue to block 225.

In block 225, the auction module 25 conducts an auction process between the merchant that defined the newly created public-type geo-fence object and one or more other merchants that own or control active public-type geo-fence objects that conflict with the newly created public-type geo-fence object. In one embodiment of the auction process, the merchant(s) that owns or controls the active public-type geo-fence objects that conflicts with the newly created public-type geo-fence object pays a certain amount of money per month to the service 15. The merchant that defined the newly created public-type geo-fence object can agree to pay an amount of money (such as a percentage increase) over the existing monthly payment. This amount of money is referred to as “opening price” for the auction process. Consider an example where Merchant A owns or controls an active public-type geo-fence object that conflicts with a newly created public-type geo-fence object of Merchant B and Merchant A currently pays $15 per month for its active public-type geo-fence object. In this case, Merchant B can agree to an opening price, such as a 20% increase over the existing $15 monthly payment. Thereafter, the merchant(s) that own or control the active public-type geo-fence objects that conflict with the newly created public-type geo-fence object can be notified of the conflict together with the opening price of the auction process. Such notification can involve messaging to the merchant(s) via the messaging services provided by the messaging module 29. The merchant(s) that owns or controls the active public-type geo-fence objects that conflict with the newly created public-type geo-fence object can be provided with an election to alter the geographic boundary and/or the category of the public-type geo-fence object and avoid the conflict. If this election occurs, the monthly price for the active public-type geo-fence object can be changed to reflect the change in the geographic boundary or other characteristics. Furthermore, if this election occurs for all conflicting geo-fence objects, the merchant that defined the newly created public-type geo-fence object is the winner of the auction. Otherwise (the case where this election does not occur for all conflicting geo-fence objects), the auction process continues whereby the merchant(s) that own or control the conflicting geo-fence object(s) has the ability to match the opening price submitted by the merchant that defined the newly created public-type geo-fence object. The merchant(s) that own or control the conflicting geo-fence object(s) can have a pre-defined amount of time to submit the matching bid. If the matching bid is submitted, the merchant that defined the newly created public-type geo-fence object can possibly increase the bid, such as agreeing to pay a percentage increase over the matching bid. The merchant that defined the newly created public-type geo-fence object can have a pre-defined amount of time to submit the increased bid. This bidding process can be repeated multiple times until a winner merchant (the merchant with the highest bid) is determined. The final price is dictated by the highest bid of the winner merchant. The other merchant(s) with lower bid(s) are referred to as loser merchant(s).

In block 227, the auction module 25 is configured to wait for completion of auction process. Upon completion of the auction process, the operations continue to block 229.

In block 229, the auction module 25 reports the results of the auction process to the merchants that participated in the auction process. Such reporting can involve messaging to such merchants via the messaging services provided by the messaging module 29. The auction module 25 can also cooperate with the payment module 31 such that the winner merchant pays the final price as determined by the results of the auction process.

In block 231, the auction module 25 is configured to wait for completion of payment by the winner merchant. Upon completion of such payment, the operations continue to block 233.

In block 233, the auction module 25 adds the public-type geo-fence object owned or controlled by the winner merchant to the inventory of geo-fence objects maintained in the database 17, if it is not there already. It will become active during its relevant term. For the case where the winner merchant is the merchant that defined the newly created public-type geo-fence object, the term is determined in block 205. For the case where the winner merchant is the merchant that owns or controls an active public-type geo-fence object that conflicts with newly created public-type geo-fence object, the term of the active public-type geo-fence object is extended as a result of the auction process.

In block 235, the auction module 25 processes the public-type geo-fence object created or controlled by each loser merchant and the operations end. For the case where the loser merchant is the merchant that defined the newly created public-type geo-fence object, the newly created public-type geo-fence object can be discarded such that it is not placed in the inventory of geo-fence objects. For the case where the loser merchant is the merchant that owns or controls an active public-type geo-fence object that conflicts with newly created public-type geo-fence object, the public-type geo-fence object can be marked inactive or removed from the inventory of public-type geo-fence objects 101 at the ends of its term.

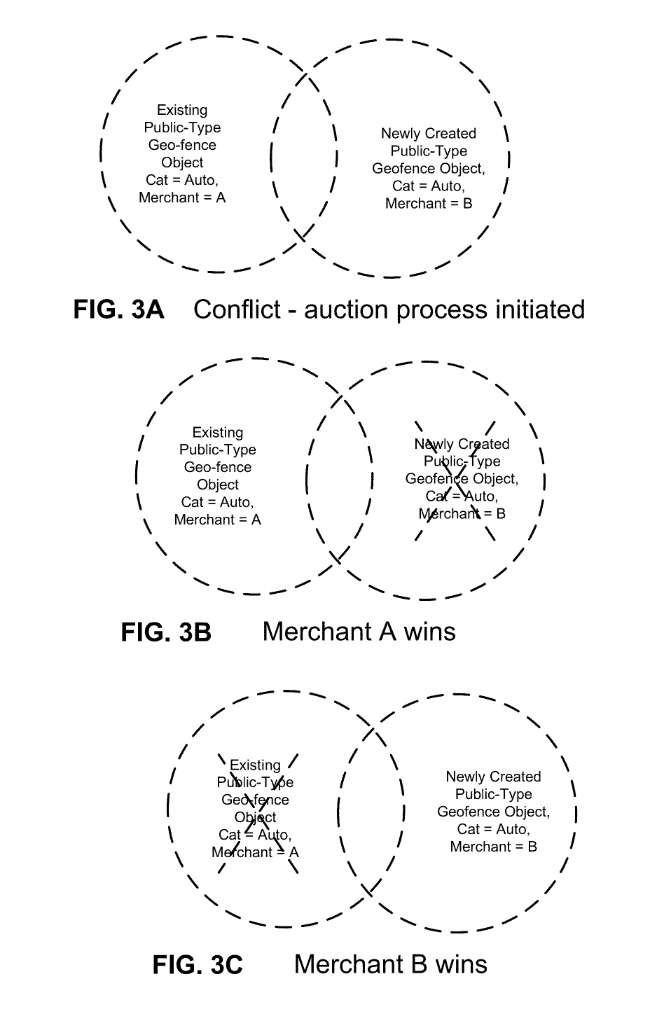

FIG. 3A is a schematic depiction illustrating conflict between an existing public-type geo-fence object owner or controlled by a Merchant A and a newly created public-type geo-fence object defined by a Merchant B, which can trigger the auction process of block 225 involving Merchant A and merchant B.

FIG. 3B illustrates the result of the auction process of block 225 where Merchant A submits the highest bid and is determined the winner merchant of the auction process. In this case, the term of the active public-type geo-fence object owned or controlled by merchant A can be extended as a result of the auction process in block 233. Merchant B is the loser merchant and the newly created public-type geo-fence object defined by Merchant B can be discarded in block 235 such that it is not placed in the inventory of geo-fence objects.

FIG. 3C illustrates the result of the auction process of block 225 where Merchant B submits the highest bid and is determined the winner merchant of the auction process. In this case, the newly created public-type geo-fence object defined by merchant B is added to the inventory of geo-fence objects maintained in the database 17 and the term of the newly created public-type geo-fence object is determined in block 205. Merchant A is the loser merchant and the public-type geo-fence object owned or controlled by Merchant A can be marked inactive or removed from the inventory of public-type geo-fence objects 101 at the ends of its term.

The service 15 can include a partner API 33 that provides an interface to one or more partner facilities (one shown as 35 in FIG. 1) via data exchange over the network 13. The partner API 33 allows the partner facility 35 to create and/or manage geo-fence objects (including public-type and/or private-type geo-fence objects) that are maintained and processed by the service 15. It is contemplated at the partner API 33 will provide data-exchange of information that mimics the functionality of the Merchant Interface 21 in creating and editing public-type geo-fence objects, participating in auction processes in conjunction with public-type geo-fence objects, and accessing reporting information of public-type geo-fence objects as described herein. The partner facility 35 can be a computer system with user input and/or automated processes that drive the data exchange with the partner API 33 that creates and/or manages geo-fence objects (including public-type and/or private-type geo-fence objects) that are maintained and processed by the service 15, participates in auction processes in conjunction with public-type geo-fence objects that are maintained and processed by the service 15, and accesses reporting information of public-type geo-fence objects that are maintained and processed by the service 15. The partner API 33 can allow the service 15 to act as part of a network or marketplace for disseminating geo-fence objects and possibly other useful information (such as digital media ads and the like). The partner API 33 can also be configured to allow partners (including merchants, publishers, aggregators, beacon providers, smart device providers including wearable technology and other entities) to publish their content as part of geo-fence objects and allow or disallow merchants large and small to associate their media content (e.g., advertisements) with any/all of their published content. The partner API 33 can also be configured to allow partners to upload their existing user data to the service. For instance, if a publisher has registration data from users who visit their website or offline user data (non-digital), that data may be compiled, uploaded and managed in the system, allowing the publisher to invite the users to the service, target users who share common characteristics to their users, or ensure that certain customers cannot encounter geo-fence objects that are created by the publisher.

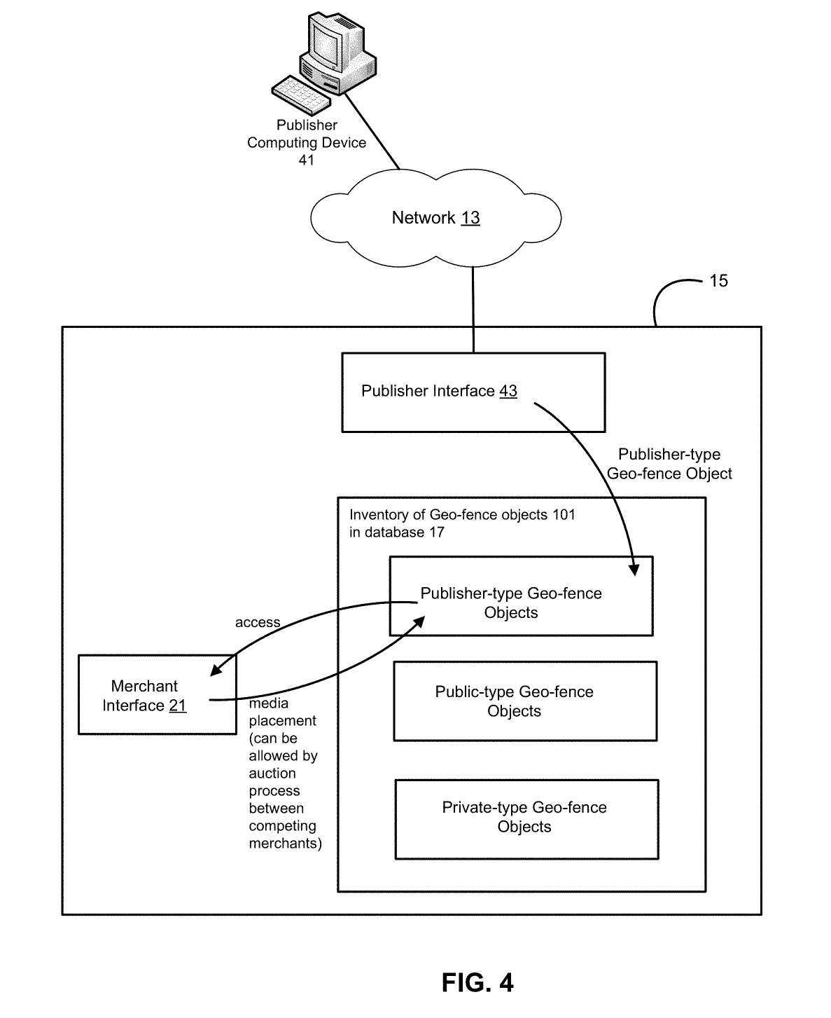

The service 15 can also support publisher-type geo-fence objects that are created and managed by one or more publisher computing devices 41 as shown in FIG. 4. The publisher-type geo-fence objects provide access to media content that is created and/or disseminated by publishers that are registered with the service 15 (such as news publishers like Google News, CNN, Dow Jones, Bloomberg, TV outlets, newspapers, etc. and/or sports publishers such as ESPN, sports leagues, TV outlets, newspapers etc., and/or beacon companies that work on behalf of major marketers (like Target Corporation), and/or other media content publishers and/or aggregators). The media content of the publisher-type geo-fence object can be related to the geo-graphical boundaries of the publisher-type geo-fence object, such as a multimedia news story that describes a local election with the geographical boundary of the publisher-type geo-fence object overlapping the voting boundary for the local election. The publisher-type geo-fence objects are similar to public-type geo-fence objects; however, the publisher that submits a given publisher-type geo-fence object need not be required to provide payment for submission of the given publisher-type geo-fence object. Furthermore, the merchant interface 21 of the service 15 can be configured to allow merchants (through data exchange with the merchant computing devices 37A, 37B, etc. or the partner API 33) to access the publisher-type geo-fence objects and place media content (such as advertisements) with the publisher-type geo-fence objects for a fee. The auction module 25 can be configured to carry out an auction process that allows two or more merchants to bid against one another in order to compete for the placement of media content with a particular publisher-type geo-fence object or group of publisher-type geo-fence objects (such as a group of publisher-type geo-fence objects published by a given publisher). After successful placement, the media content of the merchant is associated with the geo-fence object as stored in the inventory of geo-fence objects 101 maintained by the database 17. Mobile users can trip this geo-fence object and automatically access the media content of the merchant as well as the content of the publisher that is associated with the publisher-type geo-fence object as described herein. The process of creating publisher-type geo-fence objects and permitting merchant users to place media content as part of a publisher-type geo-fence object can be carried out in an automated manner by the service 15. For example, a publisher can integrate its content ‘feed’ into the service 15. In this case, the content feed can include location data (such as Lat-Long coordinates or CITY/STATE) and a category type for each media content item. The service 15 can employ rule-based processing to generate and store a publisher-type geo-fence object based on the location data and the category type of the media content item. The rule-based processing may assign different size geo-fence boundaries for different categories.

Note that placement of media content (e.g., advertisements) with publisher-type geo-fence objects can be carried out by merchants of all size as well as agents such as ad networks, ad exchanges, demand-side platforms (DSPs), rep firms, etc. The service 15 can charge fees for such placement. Fee sharing can be used where portions of such fees can be paid to the corresponding publisher.

It is also contemplated that other auction processing can be carried out by the service 15. For example, the auctioning of public-type geo-fence objects can be triggered automatically by a conflict between two or more geo-fence objects, which can be determined by geo-graphical overlap alone without any processing related to categories or category matching as described above. The auctioning can also be triggered by other automated operations, semi-automated operations or manual operations.

There have been described and illustrated herein several embodiments of a system and method of managing category-based geo-fence objects that employs automatic auction processing triggered by conflict checking of category-based geo-fence objects. While particular embodiments of the invention have been described, it is not intended that the invention be limited thereto, as it is intended that the invention be as broad in scope as the art will allow and that the specification be read likewise. Thus, while particular examples of auction processes have been disclosed, it will be appreciated that other auction processes can be used as well. In addition, while a particular cloud-based service architecture has been disclosed, it will be understood that many different architectures, including distributed computing architectures can be used as well. Also, while certain list of categories for the geo-fence objects have been disclosed, it will be recognized that other categories can be used for the geo-fence objects as needed. It will therefore be appreciated by those skilled in the art that yet other modifications could be made to the provided invention without deviating from its spirit and scope as claimed.

What is claimed is:

1. A data processing system comprising:
a database storing geo-fence objects; and
at least one module configured to automatically initiate an auction process involving a plurality of users in response to determining conflict between geo-fence objects owned or controlled by the plurality of users.

2. A data processing system according to claim 1, further comprising:
trip detection logic that communicates with a respective user mobile device to determine whether location of the respective user mobile device lies within the geographical boundaries of the geo-fence objects stored in the database.

3. A data processing system according to claim 1, wherein:
conflict between geo-fence objects owned or controlled by the plurality of users involves overlap of geographical boundaries of the geo-fence objects owned or controlled by the plurality of users.

4. A data processing system according to claim 3, wherein:
conflict between geo-fence objects owned or controlled by the plurality of users further involves the geo-fence objects sharing a common category.

5. A data processing system according to claim 1, wherein:
the geo-fence objects include public-type geo-fence objects that are associated with advertising or promotional media content.

6. A data processing system according to claim 1, wherein:
the geo-fence objects include private-type geo-fence objects each accessible by a limited number of users that are associated with the respective private-type geo-fence object.

7. A data processing system according to claim 1, wherein:
the geo-fence objects include at least one publisher-type geo-fence object that is associated with advertising or promotional media content for a user-paid fee.

8. A data processing system according to claim 7, wherein:
the auction module is further configured to allow multiple users to bid against one another for placement of the advertising or promotional media content that is part of the publisher-type geo-fence object.

9. A data processing system according to claim 1, wherein:
the auction module is configured to search through an inventory of geo-fence objects stored in the database in order to determine conflict between a newly-submitted geo-fence object and the inventory of geo-fence objects stored in the database.

10. A data processing system according to claim 1, wherein:
the auction module is configured to allow a user to modify a newly-submitted geo-fence object in order to avoid conflict with another geo-fence object before initiating an auction process involving the newly-submitted geo-fence object.

11. A data processing system according to claim 10, wherein:
the auction module is configured to allow a user to modify geographical boundary of the newly-submitted geo-fence object in order to avoid conflict with another geo-fence object.

12. A data processing system according to claim 10, wherein:
the auction module is configured to allow a user to modify category of the newly-submitted geo-fence object in order to avoid conflict with another geo-fence object.

13. A method for managing electronic geofence objects, comprising:
storing geo-fence objects in a database; and
automatically initiating an auction process involving a plurality of users in response to determining conflict between geo-fence objects owned or controlled by the plurality of users.

14. A method according to claim 12, further comprising:
communicating with a respective user mobile device to determine whether location of the respective user mobile device lies within the geographical boundaries of the geo-fence objects stored in the database.

15. A method according to claim 12, wherein:
conflict between geo-fence objects owned or controlled by the plurality of users involves overlap of geographical boundaries of the geo-fence objects owned or controlled by the plurality of users.

16. A method according to claim 15, wherein:
conflict between geo-fence objects owned or controlled by the plurality of users further involves the geo-fence objects sharing a common category.

17. A method according to claim 12, wherein:
the geo-fence objects include public-type geo-fence objects that are associated with advertising or promotional media content.

18. A method according to claim 12, wherein:
the geo-fence objects include private-type geo-fence objects each accessible by a limited number of users that are associated with the respective private-type geo-fence object.

19. A method according to claim 12, wherein:
the geo-fence objects include at least one publisher-type geo-fence object that is associated with advertising or promotional media content for a user-paid fee.

20. A method according to claim 17, wherein:
the auction process involves multiple users bidding against one another for placement of the advertising or promotional media content that is part of the publisher-type geo-fence object.

21. A method according to claim 12, further comprising:
searching through an inventory of geo-fence objects stored in the database in order to determine conflict between a newly-submitted geo-fence object and the inventory of geo-fence objects stored in the database.

22. A method according to claim 12, further comprising:
modifying a newly-submitted geo-fence object based on user input in order to avoid conflict with another geo-fence object before initiating an auction process involving the newly-submitted geo-fence object.

23. A method according to claim 22, wherein:
the modifying involves modification of a geographical boundary of the newly-submitted geo-fence object based on user input in order to avoid conflict with another geo-fence object.

24. A method according to claim 22, wherein:
the modifying involves modification of a category of the newly-submitted geo-fence object based on user input in order to avoid conflict with another geo-fence object.
